(19) United States
(12) Patent Application Publication
(10) Pub. No.: US 2008/0000064 A1
(43) Pub. Date: Jan. 3, 2008

(54) Method of Manufacturing Color Metal Zipper and Apparatus Therefor

(76) Inventor: Ching Song Chou, Chuang City (TW)

Correspondence Address: KAO H. LU, 686 LAWSON AVE, HAVERTOWN, PA, 19083, US

(21) Appl. No.: 11/426,943

(22) Filed: Jun. 28, 2006

(51) Int. Cl. B21F 45/18; B23P 25/00; B29D 5/00

(52) U.S. Cl. 29/408; 29/33.2; 29/766; 29/458

(57) ABSTRACT

Method and apparatus of manufacturing color metal zipper are disclosed. The method includes washing half-finished metal zipper; overlaying a thin film on the upper surface of half-finished metal zipper; feeding color transfer paper; overlaying the half-finished metal zipper on the color transfer paper and positioning same; intermittently advancing the overlaid half-finished metal zipper and the color transfer paper; heating and pressing the overlaid half-finished metal zipper and the color transfer paper in an interval when the advancing stops for uniformly transferring color of the color transfer paper to a portion of the half-finished metal zipper; intermittently advancing the half-finished metal zipper and the color transfer paper again; separating the finished color metal zipper from the color transfer paper while intermittently advancing; and cooling and storing the finished color metal zipper and color transfer paper.

### BACKGROUND OF THE INVENTION

1. Field of Invention

The present invention relates to metal zipper manufacturing and more particularly to a method of manufacturing color metal zipper and an apparatus therefor.

2. Description of Related Art

Color zippers are visually attractive to people. Also, there have been numerous suggestions in prior art patents for the manufacturing of color zipper. For example, U.S. Pat. No. 6,591,463 discloses a zipper with multiple and alternate colors to provide a colorful effect to garments in which the pigmented core is subjected to a color fixing process, and the core with multiple and alternate colors is embedded into the transparent zipper teeth. U.S. Pat. No. 6,279,209 discloses a color slide fastener and method and apparatus for manufacturing same in which more than two colors are formed on fastener teeth of a slide fastener by conventional injection molding. U.S. Pat. No. 4,156,303 discloses a slide fastener (i.e., zipper) and method of manufacture in which color is dyed on the tape with multi-layer fibers of the slide fastener.

However, all of the prior art patents have low yield, resulting in an increase in the manufacturing process and cost. Further, these zippers are formed of plastics. In addition, it is known that a dyeing process for manufacturing color metal zipper is complicated and encountered much difficult, such as color film prone to peel off during laundry, since metal zipper is not heat proof and surface thereof is highly polluted. Hence, as far as the present inventor is aware, there is no color metal zipper commercially available.

Thus, continuing improvements in the exploitation of color metal zipper manufacturing method and apparatus therefor are constantly being sought.

### SUMMARY OF THE INVENTION

It is therefore one object of the present invention to provide process and apparatus of manufacturing color metal zipper having advantages of high efficiency, high yield, and having a low manufacturing cost.

In one aspect of the present invention there is provided a process of manufacturing a color metal zipper comprising feeding and washing a continuous row of half-finished metal zipper; overlaying a film on the half-finished metal zipper; feeding a continuous strip of color transfer paper; overlaying the half-finished metal zipper on the color transfer paper and positioning same; intermittently advancing the overlaid half-finished metal zipper and the color transfer paper; heating and pressing the overlaid half-finished metal zipper and the color transfer paper in an interval when the advancing stops for uniformly transferring color of the color transfer paper to a portion of the half-finished metal zipper; intermittently advancing the half-finished metal zipper and the color transfer paper again; separating the finished color metal zipper from the color transfer paper while intermittently advancing; and cooling the finished color metal zipper and the color transfer paper and storing same.

In another aspect of the present invention there is provided an apparatus of manufacturing a color metal zipper comprising a bed; a controller provided on the bed and including a control box and an on/off switch; a washing assembly provided on the bed and including a first liquid reservoir and two opposing first rolls; a film overlaying assembly including an open second liquid reservoir contained with liquid material, a roll unit mounted in and above the second liquid reservoir, and a scraping unit wherein the liquid material is adhered to a surface of an advancing half-finished metal zipper passing the roll unit, the scraping unit is adapted to scrape excess liquid material out of a surface of the roll unit, and a film is formed on the half-finished metal zipper after the half-finished metal zipper leaving passing the film overlaying assembly; a feeding assembly provided on the bed and including a guide roll assembly and a guide section for feeding and intermittently advancing both the half-finished metal zipper and the color transfer paper and overlaying the half-finished metal zipper on the color transfer paper; a mold assembly provided on the bed adjacent the feeding assembly and including a mold, a heating unit, and a ram; a separation assembly provided on the bed adjacent the mold assembly and including a separation member for vertically separating the overlaid finished color metal zipper and the color transfer paper into two independent upper and lower ones, and a guiding unit for guiding the finished color metal zipper and guiding the color transfer paper respectively; and a drive mechanism provided on the bed adjacent the separation assembly and including a drive source and two opposing second rolls, the drive source being adapted to intermittently move both the finished color metal zipper and the color transfer paper a predetermined distance.

The above and other objects, features and advantages of the present invention will become apparent from the following detailed description taken with the accompanying drawings.

### BRIEF DESCRIPTION OF THE DRAWINGS

FIG. 1 is a flowchart depicting a process for manufacturing color metal zipper according to a preferred embodiment of the invention;

FIG. 2 is a side view schematically depicting an apparatus of manufacturing color metal zipper according to the invention;

FIG. 3 is a perspective view of the film overlaying assembly;

FIG. 4 is a perspective view of the film overlaying assembly in a film overlaying operation;

FIG. 5 is a longitudinal sectional view of a portion of the film overlaying assembly in FIG. 4;

FIG. 6 is a longitudinal sectional view showing two rows of interlocking tabs in an operation of transferring color from the color transfer paper to a portion of the half-finished metal zipper;

FIG. 7 is a longitudinal sectional view showing two rows of interlocking tabs having finished the film overlaying operation and having transferred color of the color transfer paper to a portion of the half-finished metal zipper;

FIG. 8 is a perspective view of the guide unit;

FIG. 9 is a perspective view of the guide unit in a guiding operation;

FIG. 10 is a longitudinal sectional view of the guide unit in FIG. 9;

FIG. 11 is a perspective view of the mold;

FIG. 12 is a perspective view of the ram to be pressed onto the joint rows of interlocking tabs passing the mold;

FIG. 13 is a front view in part section showing the ram about to press on the half-finished metal zipper passing the mold;

FIG. 14 is a side view in part section showing the mold assembly prior to operating;

FIG. 15 is a view similar to FIG. 14 where the mold assembly is operating;

FIG. 16 is a perspective view of the guiding unit;

FIG. 17 is a view similar to FIG. 16 where the guiding unit is operating; and

FIG. 18 is a perspective view of the finished rows of interlocking tabs of metal zipper in its joined state.

### DETAILED DESCRIPTION OF THE INVENTION

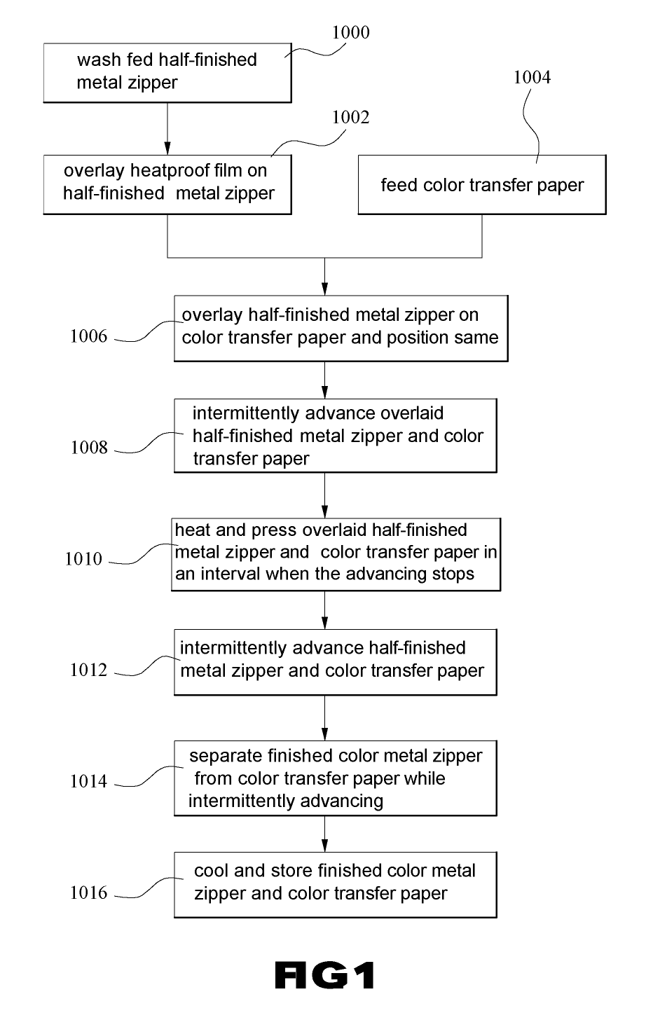

Referring to FIG. 1, a process of manufacturing color metal zipper in accordance with a preferred embodiment of the invention comprises a film overlaying operation including feeding and washing a continuous row of half-finished metal zipper (step 1000), and overlaying a heatproof film on the half-finished metal zipper (step 1002), and the heatproof film, preferably, has a thickness in a range of about 0.1 μm to about 1 μm, is adapted to operate normally in a high temperature of 160° C.-200° C., preferably at 180° C. and is manufactured from a material selected from resin such as epoxy resin or the like; a color transfer paper feeding operation including feeding a continuous strip of color transfer paper (step 1004), and overlaying the half-finished metal zipper on the color transfer paper and positioning same (step 1006) wherein the color transfer paper has a dye layer having a thickness less than 1 μm, is a continuous paper strip, and may additionally have a colorful pattern; a transfer printing operation including intermittently advancing the overlaid half-finished metal zipper and the color transfer paper (step 1008), heating and pressing the overlaid half-finished metal zipper and the color transfer paper in an interval when the advancing stops so as to uniformly transfer color of the color transfer paper to a portion of the half-finished metal zipper having a predetermined length (step 1010), and intermittently advancing the portion of the half-finished metal zipper and the color transfer paper to leave the space for a next heating and pressing step (step 1012); and a separation operation including separating the finished color metal zipper (or the finished rows of interlocking tabs) from the color transfer paper while intermittently advancing (step 1014), and cooling the finished color metal zipper (or the color rows of interlocking tabs) and the color transfer paper and storing same (step 1016).

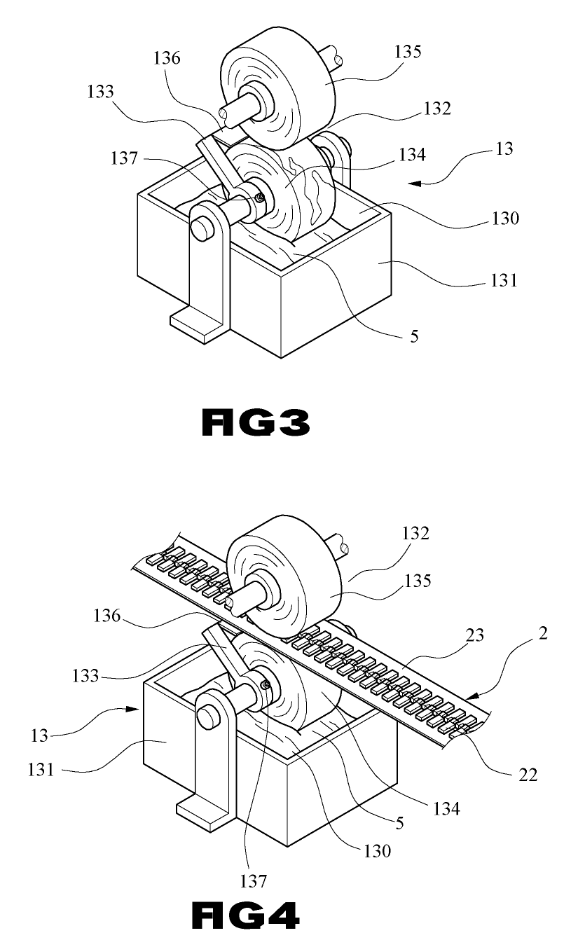

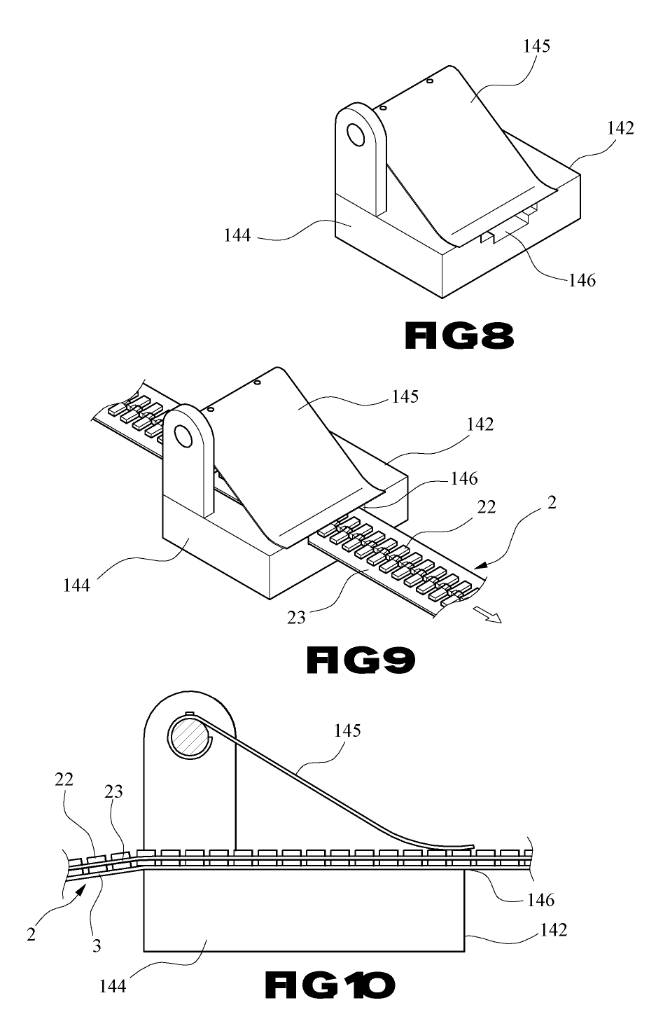

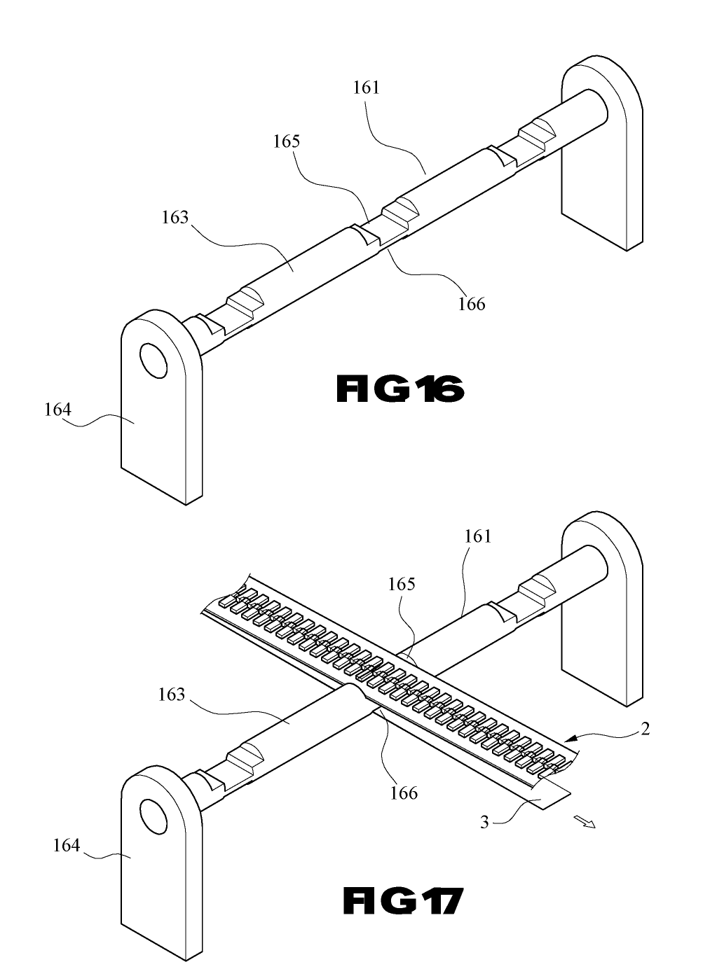

Referring to FIGS. 2 to 18, an apparatus of manufacturing color metal zipper is shown. The apparatus comprises a bed 1 including a controller 11, a washing assembly 12, a film overlaying assembly 13, a feeding assembly 14, a mold assembly 15, a separation assembly 16, a drive mechanism 17, and a conveying mechanism 18. A first supply reel (not shown) is mounted at a front end of the bed 1 with the half-finished metal zipper 2 wound around. Half-finished metal zipper 2 comprises two rows of interlocking tabs 22 and two rows of fabric 23. The bed 1 comprises a first table 10 having legs 19 and a second table 10A having legs 19A.

The controller 11 in provided between the legs 19 and includes a control box 111 having a control circuit (not shown), and an on/off switch 112 for activating the apparatus. Color transfer paper 3 is wound around a second supply reel 4 below the first table 10 and is located between the film overlaying assembly 13 and the feeding assembly 14.

The washing assembly 12 is provided on the second table 10A and comprises a liquid reservoir 121 and a pair of rotatably engaged rolls 122. The half-finished metal zipper 2 is washed by washing agent stored in the liquid reservoir 121 while passing the liquid reservoir 121. Next, the half-finished metal zipper 2 passes a very small gap between the rolls 122 in its advancing path.

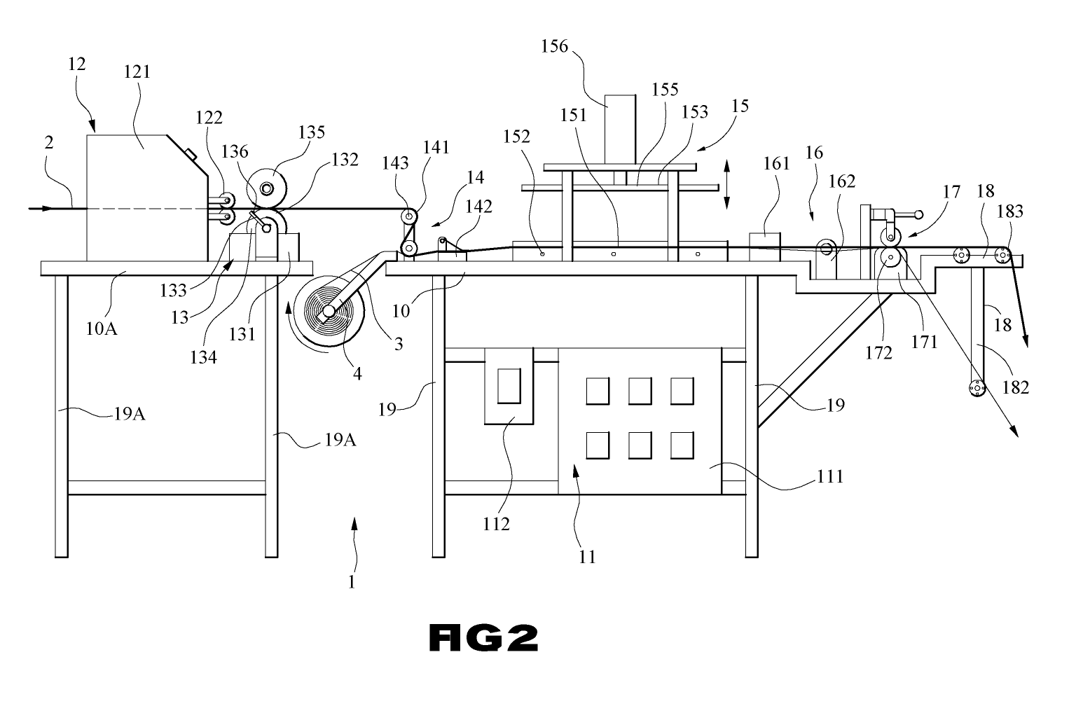

As shown in FIGS. 3 to 7, the film overlaying assembly 13 comprises an open reservoir 131 having a space 130 contained with liquid, high heatproof material 5 such as epoxy resin or the like, a roll unit 132 mounted in and above the reservoir 131 and including first and second rolls 134 and 135 vertically provided, an adjustable scraping unit 133 mounted with the roll unit 132 and including a scraper 136 in close proximity with a surface of the first roll 134, and an adjustment member (e.g., screw) 137 for adjusting a distance between the scraper 136 and the surface of the first roll 134. In operation, the advancing half-finished metal zipper 2 passes the gap between the rolls 134 and 135. Thus, liquid, heatproof material 5 is adhered to surface of the half-finished metal zipper 2. At the same time, excess liquid, heatproof material 5 is scraped out of the surface of the first roll 134. Eventually, a heatproof material film 21 is formed on the half-finished metal zipper 2 after the half-finished metal zipper 2 passing the film overlaying assembly 13. The heatproof film 21, preferably, has a thickness in a range of about 0.1 μm to about 1 μm, is adapted to operate normally in a high temperature of about 180° C. and is manufactured from a material selected from resin such as epoxy resin or the like.

The feeding assembly 14 is provided on the first table 10 proximate the film overlaying assembly 13 and includes a guide roll assembly 141 and a guide unit 142. The guide roll assembly 141 includes two rolls 143 for feeding the half-finished metal zipper 2 from the film overlaying assembly 13 and the color transfer paper 3 from the second supply reel 4 to the guide unit 142 and overlaying the half-finished metal zipper 2 on the color transfer paper 3. As shown in FIGS. 8, 9, and 10, the guide unit 142 includes a rectangular base 144 having a central lengthwise groove 146 on a top surface, and a spring biased pivotal plate 145 obliquely mounted on the base 144. The groove 146 has a width slightly larger than that of each of the half-finished metal zipper 2 and the color transfer paper 3. The overlaid half-finished metal zipper 2 and color transfer paper 3 pass the groove 146 in the advancing operation.

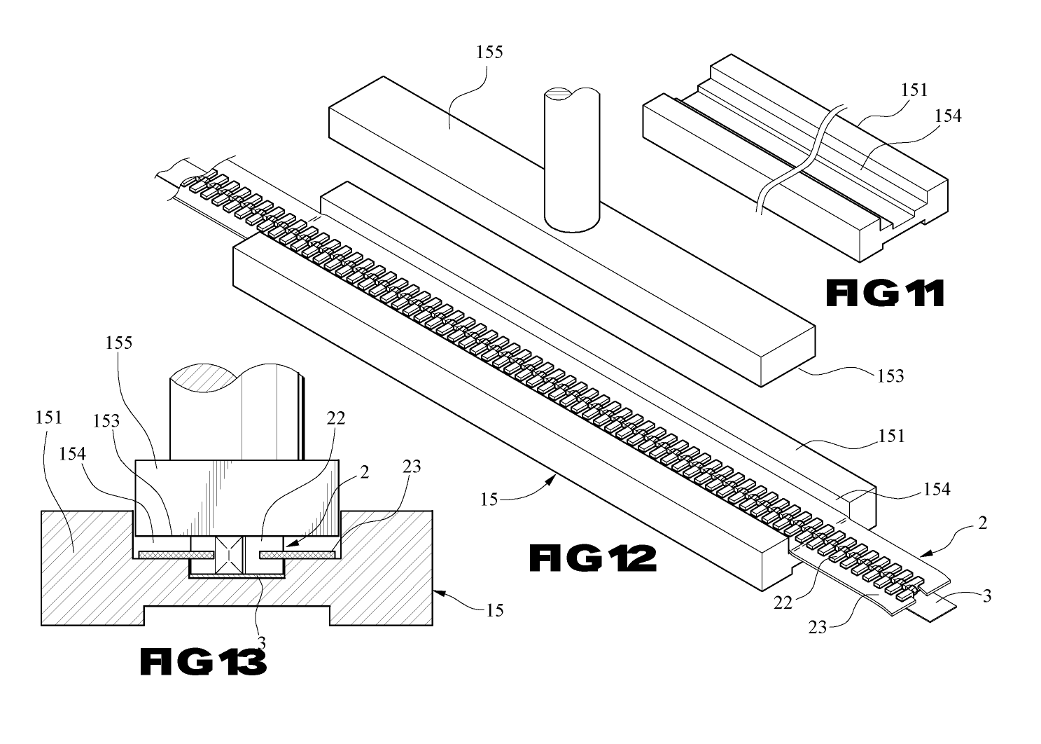

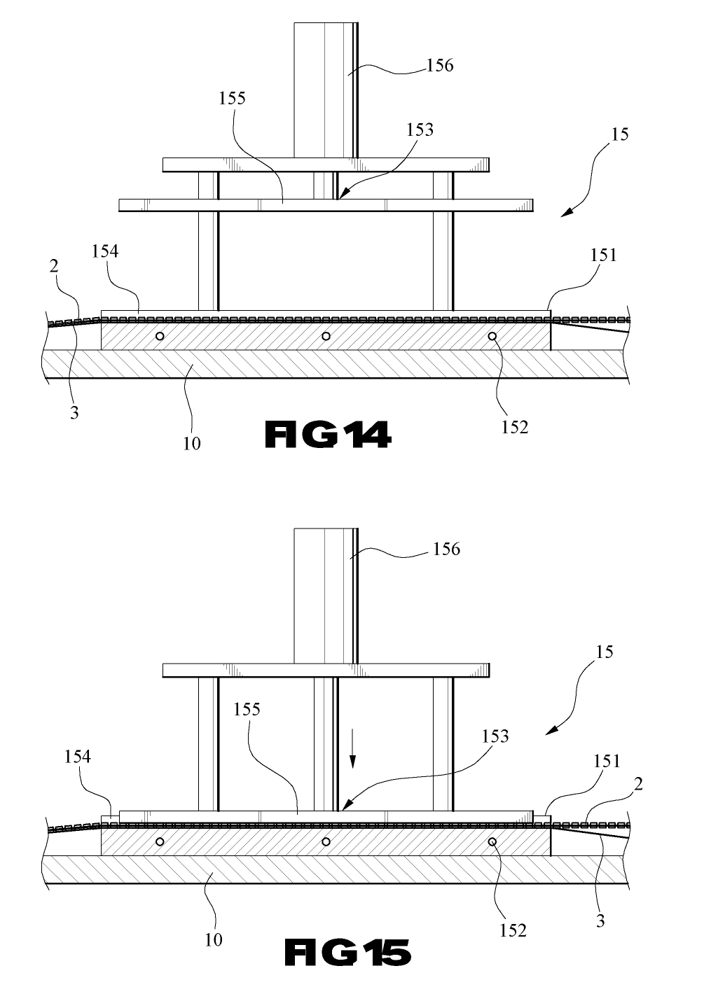

The mold assembly 15 is provided on the table 10 adjacent the feeding assembly 14 as a next stage. As shown in FIGS. 11 to 15, the mold assembly 15 comprises a mold 151, a heating unit 152, and a ram 153. The mold 151 is an elongated member and comprises a central lengthwise trough 154 on its top surface for allowing the overlaid half-finished metal zipper 2 and the color transfer paper 3 to pass thereon. The heating unit 152 is mounted in a bottom the mold 151 and is adapted to heat the overlaid half-finished metal zipper 2 and the color transfer paper 3. Heating time of the heating unit 152 is controlled by the controller 11. The ram 153 has an end block 155 having a length equal to or slightly less than that of the mold 151. The block 155 is driven by a drive unit (e.g., hydraulic or pneumatic cylinder) 156 such that the block 155 may move vertically to press the overlaid half-finished metal zipper 2 and color transfer paper 3 in an operation when they temporarily stops in the trough 154 as shown in FIGS. 6, 14 and 15. Advancing of the overlaid half-finished metal zipper 2 and color transfer paper 3 is intermittent in cooperation with the drive mechanism 17. Also, the heating unit 152 is adapted to heat the overlaid half-finished metal zipper 2 and color transfer paper 3 in an interval when the advancing stops in the trough 154. Thus, the ram 153 is pressed on the overlaid half-finished metal zipper 2 and the color transfer paper 3 passing the trough 154 (see FIG. 13).

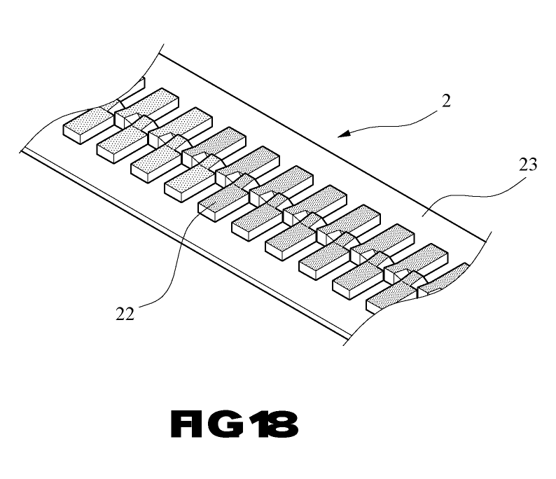

The separation assembly 16 is provided on the table 10 adjacent the mold assembly 15 as a next stage. As shown in FIGS. 16 and 17, the separation assembly 16 includes a separation member 161 for vertically separating the overlaid finished color metal zipper 2 and the color transfer paper 3 into two independent upper and lower ones, a guiding unit 162, and a cross-rail 163 mounted across two legs 164. On the cross-rail 163 there are provided a plurality of upper indents 165 and a plurality of lower indents 166 disposed just below the upper indents 165. The upper indents 165 are adapted to guide the finished color metal zipper 2 and the lower indents 166 are adapted to guide the color transfer paper 3 respectively.

The drive mechanism 17 is provided on the table 10 adjacent the separation assembly 16 as a next stage. As shown in FIG. 2, the drive mechanism 17 comprises a drive source (e.g., step motor) 171 and two opposing rolls 172 in which one is a drive roll and the other is an idler roll. The drive source 171 is adapted to intermittently move the finished color metal zipper 2 and the color transfer paper 3 a predetermined distance per time interval. Preferably, the predetermined distance is equal to the length of the mold 151. Preferably, the stop time of the drive source 171 is equal to or longer than the heating time. This can be set by the controller 11.

The conveying mechanism 18 is provided at a rear end of the first table 10 adjacent the drive mechanism 17 as shown in FIG. 2. The conveying mechanism 18 comprises a first guide unit 181 and a second guide unit 182. Each of the first and second guide units 181 and 182 comprises one or more guide rolls 183 for guiding and forwarding the finished color metal zipper 2 including two rows of interlocking tabs 22 and two rows of fabric 23 (see FIG. 18) and the color transfer paper 3 to their destinations respectively.

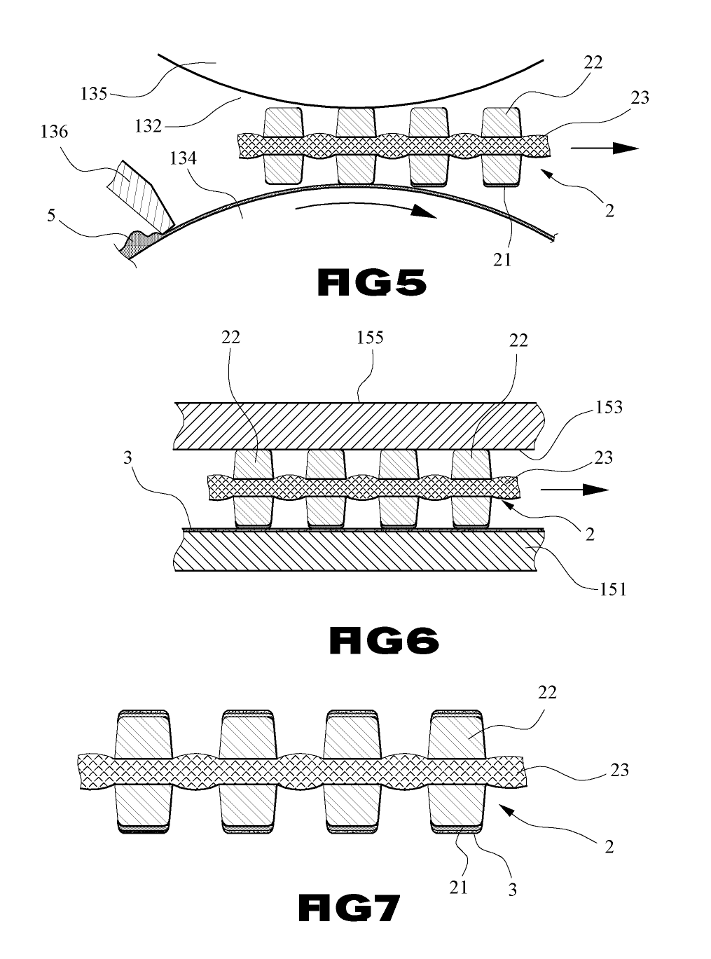

Note that the fabric 23 is not in contact with the color transfer paper 3 in the trough 154. Thus, the fabric 23 will not be dyed by the passing color transfer paper 3. Further, color or color pattern of the color transfer paper 3 will uniformly transfer to the surface of the heatproof film 21 of interlocking tabs 22 as shown in FIG. 7.

While the invention herein disclosed has been described by means of specific embodiments, numerous modifications and variations could be made thereto by those skilled in the art without departing from the scope and spirit of the invention set forth in the claims.

What is claimed is:

1. A process of manufacturing a color metal zipper comprising:
feeding and washing a continuous row of half-finished metal zipper;
overlaying a film on the half-finished metal zipper;
feeding a continuous strip of color transfer paper;
overlaying the half-finished metal zipper on the color transfer paper and positioning same;
intermittently advancing the overlaid half-finished metal zipper and the color transfer paper;
heating and pressing the overlaid half-finished metal zipper and the color transfer paper in an interval when the advancing stops for uniformly transferring color of the color transfer paper to a portion of the half-finished metal zipper;
intermittently advancing the half-finished metal zipper and the color transfer paper again;
separating the finished color metal zipper from the color transfer paper while intermittently advancing; and
cooling the finished color metal zipper and the color transfer paper and storing same.

2. The method of claim 1, wherein the film is a heatproof material.

3. The method of claim 1, wherein the heatproof material has a thickness in a range of about 0.1 μm to about 1 μm.

4. The method of claim 1, wherein the heatproof material is adapted to operate normally in a high temperature of 160° C.-200° C.

5. The method of claim 2, wherein the heatproof material is manufactured from a material selected from resin such as epoxy resin.

6. The method of claim 1, wherein the portion of the half-finished metal zipper having color uniformly transferred thereon has a predetermined length.

7. An apparatus of manufacturing a color metal zipper comprising:
a bed;
a controller provided on the bed and including a control box and an on/off switch;
a washing assembly provided on the bed and including a first liquid reservoir and two opposing first rolls;
a film overlaying assembly including an open second liquid reservoir contained with liquid material, a roll unit mounted in and above the second liquid reservoir, and a scraping unit wherein the liquid material is adhered to a surface of an advancing half-finished metal zipper passing the roll unit, the scraping unit is adapted to scrape excess liquid material out of a surface of the roll unit, and a film is formed on the half-finished metal zipper after the half-finished metal zipper leaving passing the film overlaying assembly;
a feeding assembly provided on the bed and including a guide roll assembly and a guide section for feeding and intermittently advancing both the half-finished metal zipper and the color transfer paper and overlaying the half-finished metal zipper on the color transfer paper;
a mold assembly provided on the bed adjacent the feeding assembly and including a mold, a heating unit, and a ram;
a separation assembly provided on the bed adjacent the mold assembly and including a separation member for vertically separating the overlaid finished color metal zipper and the color transfer paper into two independent upper and lower ones, and a guiding unit for guiding the finished color metal zipper and guiding the color transfer paper respectively; and
a drive mechanism provided on the bed adjacent the separation assembly and including a drive source and two opposing second rolls, the drive source being adapted to intermittently move both the finished color metal zipper and the color transfer paper a predetermined distance.

8. The apparatus of claim 7, further comprising a conveying mechanism provided on the bed adjacent the drive mechanism and including first guide unit and a second guide unit, the first and the second guide units adapted to guide the finished color metal zipper and the color transfer paper respectively.

9. The apparatus of claim 8, wherein each of the first and the second guide unit comprises one or more third rolls.

10. The apparatus of claim 7, wherein the bed comprises a first table and a second table each has a plurality of legs formed thereunder.

11. The apparatus of claim 10, further comprising a first supply reel mounted at a front end of the second table for winding the half-finished metal zipper, and a second supply reel mounted below a front end of the first table and located between the film overlaying assembly and the feeding assembly for winding the color transfer paper.

12. The apparatus of claim 7, wherein the guide section includes a rectangular base having a central lengthwise groove on a top surface, and a spring biased pivotal plate obliquely mounted on the base.

13. The apparatus of claim 7, wherein the mold is elongated and includes a central lengthwise trough on a top surface for allowing the overlaid half-finished metal zipper and the color transfer paper to pass thereon in the advancing.

14. The apparatus of claim 7, wherein the heating unit is mounted in a bottom of the mold and is adapted to heat the overlaid half-finished metal zipper and the color transfer paper, and wherein a heating temperature and time of the heating unit are controlled by the controller.

15. The apparatus of claim 7, wherein the ram includes an end block having a length equal to or slightly less than that of the mold, and the mold assembly further comprises a drive unit operatively connected to the ram so as to move the block to press the overlaid half-finished metal zipper and the color transfer paper when they temporarily stop in the mold.

16. The apparatus of claim 15, wherein the drive unit is a hydraulic or pneumatic cylinder.

17. The apparatus of claim 7, wherein the guiding unit includes two legs and a cross-rail mounted across the legs, the cross-rail including a plurality of upper indents adapted to guide the finished color metal zipper, and a plurality of lower indents disposed below the upper indents adapted to guide the color transfer paper.

18. The apparatus of claim 7, wherein the predetermined distance is equal to a length of the mold, and a stop time of the drive source is equal to or longer than the heating time.

19. The method of claim 4, wherein the heatproof material is adapted to operate preferably at 180° C.
